(19) United States
(12) Patent Application Publication
(10) Pub. No.: US 2024/0427553 A1
(43) Pub. Date: Dec. 26, 2024

(54) CONDITIONAL CALCULATOR, CONDITIONAL CALCULATION METHOD AND CONDITIONAL CALCULATION SYSTEM

(71) Applicant: SAMSUNG ELECTRONICS CO., LTD., SUWON-SI (KR)

(72) Inventors: JONGYEON PARK, Suwon-si (KR); JIMYUNG NA, Suwon-si (KR); SEOKHIE HONG, Seoul (KR); GYUSANG KIM, Seoul (KR); DONG-JUN PARK, Seoul (KR); DAEHYEON BAE, Seoul (KR); MYUNG-HUN LEE, Seoul (KR); JANGWON JU, Suwon-si (KR)

(73) Assignee: KOREA UNIVERSITY RESEARCH AND BUSINESS FOUNDATION, Seoul (KR)

(21) Appl. No.: 18/626,655

(22) Filed: Apr. 4, 2024

(30) Foreign Application Priority Data
Apr. 4, 2023 (KR) 10-2023-0044402

(51) Int. Cl. G06F 5/01; G06F 7/523

(52) U.S. Cl. CPC G06F 5/01; G06F 7/523

(57) ABSTRACT

A conditional calculator includes an input unit configured to receive a first operand, a second operand, and a control value and a calculation unit configured to perform a conditional operation in which a determination is made as to whether a predetermined operation is performed on the first and second operands, depending on the control value. The calculation unit may perform the conditional operation based on an operation of left-shifting an intermediate value of the conditional operation according to the control value or an operation of multiplying the intermediate value of the conditional operation by the control value.

### CROSS-REFERENCE TO RELATED APPLICATION(S)

This application claims priority under 35 U.S.C. § 119 to Korean Patent Application No. 10-2023-0044402 filed on Apr. 4, 2023, in the Korean Intellectual Property Office, the disclosure of which is incorporated by reference herein in its entirety.

### BACKGROUND

Example embodiments relate to a conditional calculator, a conditional calculation method, and a conditional calculation system.

As the vulnerability of public-key cryptography according to the related arts to quantum algorithms has been revealed and the development of quantum computers has become a reality, interest in post-quantum cryptography (PQC) is growing.

Conditional operations using control bits are employed in a key generation process of fast Fourier lattice-based compact signatures over NTRU (FALCON), a standard electronic signature algorithm of PQC. FALCON algorithm is vulnerable to side-channel attacks based on power analysis during conditional operations. The term “side-channel attack” refers to an attack that exploits information generated during physical implementation of a cryptography system, for example, information on decryption by analyzing timing of operation, power consumption of a device, and electromagnetic waves generated by the device.

Conditional operations using control bits are also used in various other algorithms in addition to the FALCON algorithm, and security issues may arise from side-channel attacks based on power analysis.

### SUMMARY

Example embodiments provide a conditional calculator, a conditional calculation method, and a conditional calculation system for performing conditional calculations securely against side-channel attacks.

According to an example embodiment, a conditional calculator includes an input unit configured to receive a first operand, a second operand, and a control value and a calculation unit configured to perform a conditional operation in which a determination is made as to whether a predetermined operation is performed on the first and second operands, depending on the control value. The calculation unit may perform the conditional operation based on an operation of left-shifting an intermediate value of the conditional operation according to the control value or an operation of multiplying the intermediate value of the conditional operation by the control value.

The control value may include a first value, representing a condition in which the predetermined operation is not performed, and a second value representing a condition in which the predetermined operation is performed. The calculation unit may be configured to left-shift the intermediate value of the conditional operation by the first value and output the first operand based on the intermediate value left-shifted by the first value when the control value is the first value, and left-shift the intermediate value of the conditional operation by the second value and output a result value of the predetermined operation on the first and second operands based on the intermediate value left-shifted by the second value when the control value is the second value.

The control value may have a value of 0 or 1.

The conditional calculator may include a control value conversion unit configured to convert the first and second values into 0 or 1 when the first and second values are not 0 or 1.

The conditional operation may include at least one of a conditional swap operation to replace the first operand with the second operand based on to the control value, a conditional addition operation to add the second operand to the first operand based on the control value, and a conditional subtraction operation to subtract the second operand from the first operand based on the control value.

The calculation unit may perform the conditional swap operation through the following equation:

$$2 x - y + ( y - x ) ≪ cv ,$$

where x is the first operand, y is the second operand, cv is the control value, − is a subtraction operator, + is an addition operator, << is a left-shift operator, and an operation order complies with a standard operation order.

The calculation unit may perform the conditional swap operation through the following equation:

$$z ← x ⊕ ( ( x ⊕ y ) ∧ a )$$

$$x ← z ⊕ ( ( x ⊕ y ) ∧ ( 2 a - b + ( b - a ) ≪ cv ) ) ,$$

where x is the first operand, y is the second operand, cv is the control value, a and b are arbitrary two numbers having the same Hamming weight, z is a variable in which a value of an operation x⊕((x⊕y)Λa) is stored, ⊕ is an exclusive OR (XOR) operator, Λ is a logical AND operator, − is a subtraction operator, + is an addition operator, << is a left-shift operator, and an operation order complies with a standard operation order.

The calculation unit may perform the conditional addition operation through the following equation:

$$x - y + ( y ≪ cv ) ,$$

where x is the first operand, y is the second operand, cv is the control value, − is a subtraction operator, + is an addition operator, << is a left-shift operator, and an operation order complies with a standard operation order.

The calculation unit may perform the conditional addition operation using the following equation:

$$z ← y ∧ a$$

$$x ← x + z ⊕ ( y ∧ ( 2 a - b + ( b - a ) ≪ cv ) ) ,$$

where x is the first operand, y is the second operand, cv is the control value, a and b are arbitrary two numbers having the same Hamming weight, z is a variable in which a value of an operation yΛa is stored, ⊕ is an exclusive OR (XOR) operator, Λ is a logical AND operator, − is a subtraction operator, + is an addition operator, << is a left-shift operator, and an operation order complies with a standard operation order.

The calculation unit may perform the conditional subtraction operation through the following equation:

$$x + y - ( y ≪ cv ) ,$$

where x is the first operand, y is the second operand, cv is the control value, − is a subtraction operator, + is an addition operator, << is a left-shift operator, and an operation order complies with a standard operation order.

The calculation unit may perform the conditional subtraction operation through the following equation:

$$z ← y ∧ a$$

$$x ← x - z ⊕ ( y ∧ ( 2 a - b + ( b - a ) ≪ cv ) ) ,$$

where x is the first operand, y is the second operand, cv is the control value, a and b are arbitrary two numbers having the same Hamming weight, z is a variable in which a value of an operation yΛa is stored, ⊕ is an exclusive OR (XOR) operator, Λ is a logical AND operator, − is a subtraction operator, + is an addition operator, << is a left-shift operator, and an operation order complies with a standard operation order.

The control value may include a first value, representing a condition in which the predetermined operation is not performed, and a second value representing a condition in which the predetermined operation is performed. The calculation unit may be configured to output the first operand based on an operation of multiplying the intermediate value of the conditional operation by the first value when the control value is the first value, and output a result value of the predetermined operation on the first and second operands based on an operation of multiplying the intermediate value of the conditional operation by the second value when the control value is the second value.

The control value may have a value of 0 or 1.

The conditional calculator may include a control value conversion unit configured to convert the first and second values into 0 or 1 when the first and second values are not 0 or 1.

The calculation unit may perform a conditional swap operation to replace the first operand with the second operand based on the control value through the following equation:

$$x + ( y - x ) * cv ,$$

where x is the first operand, y is the second operand, cv is the control value, − is a subtraction operator, + is an addition operator, * is a multiplication operator, and an operation order complies with a standard operation order.

The calculation unit may perform a conditional addition operation to add the second operand to the first operand based on the control value through the following equation:

$$x + ( y ) * cv ,$$

where x is the first operand, y is the second operand, cv is the control value, + is an addition operator, * is a multiplication operator, and an operation order complies with a standard operation order.

The calculation unit may perform a conditional subtraction operation to subtract the second operand from the first operand based on the control value through the following equation:

$$x - ( y ) * cv ,$$

where x is the first operand, y is the second operand, cv is the control value, − is a subtraction operator, * is a multiplication operator, and an operation order complies with a standard operation order.

According to an example embodiment, a conditional calculation method of a processor includes receiving a first operand, a second operand, and a control value and performing a conditional operation in which a predetermined operation is performed or not performed on the first and second operands, based on the control value. The performing the conditional operation may include performing the conditional operation based on an operation of left-shifting the intermediate value of the predetermined operation according to the control value or an operation of multiplying the intermediate value of the predetermined operation by the control value.

According to an example embodiment, a conditional calculation system includes a conditional calculator configured to perform a conditional operation in which whether a determination is made as to whether a predetermined operation is performed, based on a control value and a processor connected to the conditional calculator. The processor may provide a first operand, a second operand, and a control value to the conditional calculator. The conditional calculator may perform the conditional operation on the first and second operands based on an operation of left-shifting an intermediate value of the predetermined operation according to the control value or an operation of multiplying the intermediate value of the predetermined operation by the control value, and may return a result of performing the conditional operation to the processor.

The predetermined operation may include at least one of a conditional swap operation, a conditional addition operation, and a conditional subtraction operation used in a fast Fourier lattice-based compact signatures over NTRU (FALCON) algorithm.

### BRIEF DESCRIPTION OF DRAWINGS

The above and other aspects, features, and advantages of the present disclosure will be more clearly understood from the following detailed description, taken in conjunction with the accompanying drawings.

FIG. 1 is a block diagram of a conditional calculator according to an example embodiment.

FIG. 2 is a block diagram illustrating the configuration of a conditional calculator according to an example embodiment.

FIG. 3A is a diagram illustrating an example of performing a conditional swap operation based on a left-shift operation.

FIG. 3B is a diagram illustrating an example of performing a conditional swap operation based on a multiplication operation of a control value.

FIG. 4 is a block diagram illustrating the configuration of a conditional calculator according to an example embodiment.

FIG. 5 is a block diagram illustrating the configuration of a conditional calculator according to an example embodiment.

FIG. 6 is a diagram illustrating an example of performing a conditional swap operation using two numbers having the same Hamming weight.

FIG. 7 is a block diagram illustrating the configuration of a conditional calculator according to an example embodiment.

FIG. 8A is a diagram illustrating an example of performing a conditional addition operation based on a left-shift operation.

FIG. 8B is a diagram illustrating an example of performing a conditional addition operation based on a multiplication calculation of a control value.

FIG. 9 is a block diagram illustrating the configuration of a conditional calculator according to an example embodiment.

FIG. 10 is a diagram illustrating an example of performing a conditional addition operation using two numbers having the same Hamming weight.

FIG. 11 is a block diagram illustrating the configuration of a conditional calculator according to an example embodiment.

FIG. 12A is a diagram illustrating an example of performing a conditional subtraction operation based on a left-shift operation.

FIG. 12B is a diagram illustrating an example of performing a conditional subtraction operation based on a multiplication calculation of a control value.

FIG. 13 is a block diagram illustrating the configuration of a conditional calculator according to an example embodiment.

FIG. 14 is a diagram illustrating an example of performing a conditional subtraction operation using two numbers having the same Hamming weight.

FIG. 15 is a block diagram illustrating the configuration of a conditional calculator according to an example embodiment.

FIG. 16 is a flowchart illustrating a conditional calculation method according to an example embodiment.

FIG. 17A is a diagram illustrating an example of how to implement a conditional calculation system according to an example embodiment.

FIG. 17B is a diagram illustrating an example of how to implement a conditional calculation system according to an example embodiment.

FIG. 17C is a diagram illustrating an example of how to implement a conditional calculation system according to an example embodiment.

### DETAILED DESCRIPTION

Hereinafter, example embodiments will be described with reference to the accompanying drawings.

FIG. 1 is a block diagram of a conditional calculator according to an example embodiment. Referring to FIG. 1, a conditional calculator 100 may include an input unit 110 and an operation unit 120.

The input unit 110 may receive various types of data necessary for the operation of the calculation unit 120. For example, the input unit 110 may receive a first operand, a second operand, and a control value from an external device, but example embodiments are not limited thereto.

The calculation unit 120 may perform a conditional operation on the first and second operands received through the input unit 110. In an example embodiment, a conditional operation may be an operation that outputs a result in which a predetermined operation is not performed or a result in which the operation is performed, depending on conditions. The predetermined operation may include at least one of swap operation, addition operation, and subtraction operation, but example embodiments are not limited thereto.

In an example embodiment, the calculation unit 120 may perform a conditional operation in which execution of a predetermined operation on the first and second operands is determined by a control value.

For example, the control value may have a first value, indicating a condition in which a predetermined operation is not performed, or a second value indicating a condition in which a predetermined operation is performed. Accordingly, when the control value is the first value, the calculation unit 120 may perform a conditional operation to output a result value (for example, the first operand) in which a predetermined operation is not performed on the first and second operands. In addition, when the control value is the second value, the calculation unit 120 may perform a conditional operation to output a result value in which a predetermined operation is performed on the first and second operands.

As described above, the calculation unit 120 may output a result value based on the control value after performing the same conditional operation even when the control value has any value, so that a conditional operation that is secure from timing attacks may be performed.

In an example embodiment, the calculation unit 120 may perform a conditional operation based on an operation that left-shifts an intermediate value of the conditional operation according to the control value or an operation that multiplies the intermediate value of the conditional operation by the control value.

For example, the calculation unit 120 may reflect the control value into the conditional operation through a left-shift operation or a multiplication operation based on the control value. Accordingly, a conditional operation that reduces a Hamming weight difference of the intermediate value corresponding to the control value may be performed. As a result, a conditional operation that is secure from side-channel attacks by power analysis may be performed.

A more detailed description will now be provided. In general, a FALCON algorithm uses a conditional operation using a control value during the key generation process. A conditional operation, performing different functions depending on the control value, may generally be implemented using an if statement. However, when a conditional operation is implemented using an if statement, there is a time variation in execution of each function depending on a control value. Therefore, the FALCON algorithm is vulnerable to a timing attack, one of the side-channel attacks.

Accordingly, FALCON algorithm generally implements a conditional operation using operations having a constant execution time, such as the following equations 1, 2, and 3, when a control value has a value of 0 or 1. When the control value is 0 or 1, the control value may also be referred to as a control bit.

The following Equation 1 represents a conditional swap operation equation, Equation 2 represents a conditional addition operation equation, and Equation 3 represents a conditional subtraction operation equation. In the following Equations 1 to 3, x and y represent operands, cv represents a control bit, ⊕ represents an exclusive OR (XOR) operator, Λ represents a logical AND operator, and the operation order complies with the standard operation order.

$$x ⊕ ( ( x ⊕ y ) ∧ - c v ) \qquad [ Equation 1 ]$$

$$x + ( y ∧ - cv ) \qquad [ Equation 2 ]$$

$$x - ( y ∧ - cv ) \qquad [ Equation 3 ]$$

From Equations 1 to 3, it can be seen that operation timing when cv is 0 is the same as operation timing when cv is 1.

A power analysis method, a type of side-channel attack method, is an analysis method based on the characteristic in which power consumed by a device performing an encryption operation has a Hamming weight and the linearity of an intermediate value. The term “intermediate value” may refer to all values of a corresponding operation process. For example, in Equation 1, x, y, cv, −cv, x⊕y, ((x⊕y)Λ−cv), and x⊕((x⊕y)Λ−cv) may all be intermediate values. The term “Hamming weight” refers to the number of non-zero bits in a corresponding value.

Accordingly, when an intermediate value having a large Hamming weight difference is used during a conditional operation, confidential keys of a cryptographic operation such as cryptographic keys may be exposed through the power waveform analysis of the device.

From Equations 1 to 3, it can be seen that a control bit-related intermediate value −cv, among intermediate values of respective operations, becomes 0(0x00000000) or −1(0xFFFFFFFF), resulting in a significantly large Hamming weight difference. For example, a general FALCON algorithm is vulnerable to power analysis attacks as well as timing attacks.

The calculation unit 120 according to an example embodiment may reflect a control value into a conditional operation through a left-shift operation based on the control value or a multiplication operation based on the control value. Accordingly, a Hamming weight difference of an intermediate value corresponding to the control value may be reduced. As a result, a conditional operation, secure against side-channel attacks based on power analysis, may be performed.

As described above, according to an example embodiment, a conditional operation may be performed securely against power analysis attacks as well as timing attacks.

According to various embodiments, the conditional calculator 100 may perform various conditional operations depending on the type of the above-described predetermined operation. For example, the conditional calculator 100 may perform at least one of a conditional swap operation to replace the first operand with the second operand based on the control value, a conditional addition operation to add the second operand to the first operand based on the control value, and a conditional subtraction operation to subtracts the second operand from the first operand based on the control value.

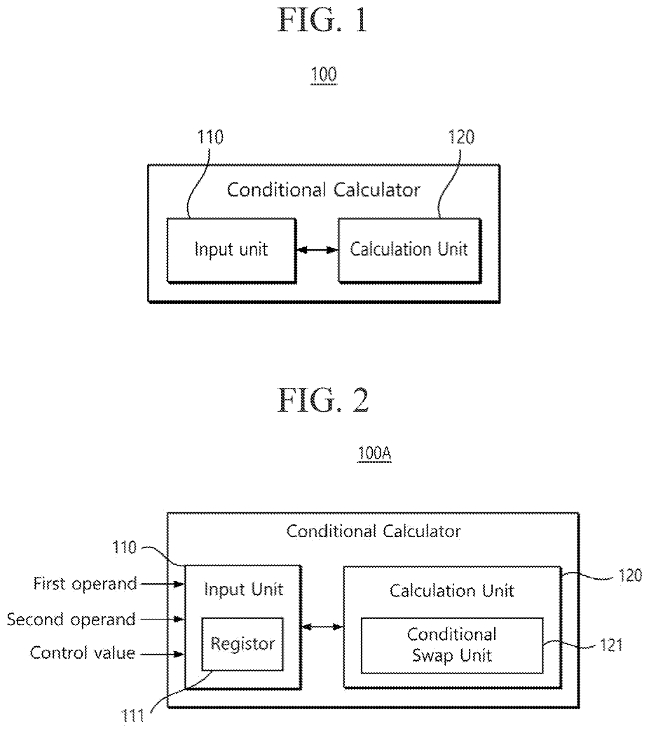

Hereinafter, various embodiments related to conditional swap operation will be described with reference to FIGS. 2 to 6.

FIG. 2 is a block diagram illustrating the configuration of a conditional calculator according to an example embodiment. Referring to FIG. 2, a conditional calculator 100A may include an input unit 110 and a calculation unit 120.

The input unit 110 may receive a first operand, a second operand, and a control value. For example, the input unit 110 may receive the first operand, the second operand, and the control value from an external memory or processor, but example embodiments are not limited thereto.

The input unit 110 may include a register 111. In an example embodiment, the register 111 may be a buffer register storing operands required for an operation, but example embodiments are not limited thereto. For example, the first operand, the second operand, and the control value may be stored in the register 111. The calculation unit 120 may read a value of the register 111 and use the read value in an operation.

The calculation unit 120 may perform a conditional swap operation. To this end, the calculation unit 120 may include a conditional swap unit 121. The conditional swap unit 121 may perform a conditional swap operation to replace the first operand with the second operand based on the control value. In an example embodiment, the control value may include a first value, indicating a condition in which the swap operation is not performed, and a second value indicating a condition in which the swap operation is performed.

According to an example embodiment, the conditional swap unit 121 may perform a conditional swap operation based on an operation that left-shifts an intermediate value of the conditional swap operation based on the control value.

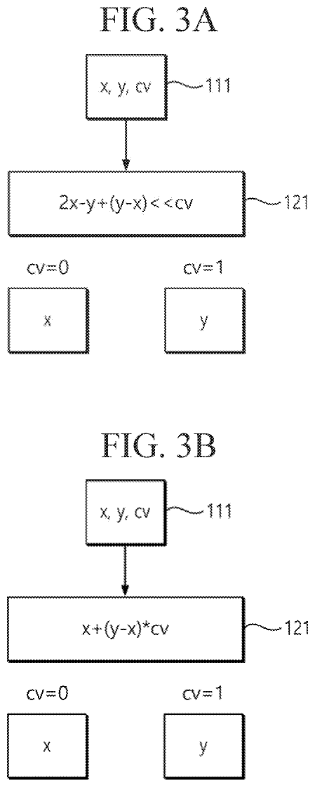

FIG. 3A is a diagram illustrating an example of how the conditional swap unit 121 performs a conditional swap operation based on a left-shift operation. FIG. 3A illustrates the case in which a first value is 0 and a second value is 1, but example embodiments are not limited thereto.

According to an example embodiment, the conditional swap unit 121 may perform a conditional swap operation based on the following Equation 4, a conditional swap operation equation.

$$2 x - y + ( y - x ) ≪ cv , \qquad [ Equation 4 ]$$

where x is a first operand, y is a second operand, cv is a control value, − is a subtraction operator, + is an addition operator, << is a left-shift operator, and the operation order complies with the standard operation order.

Referring to FIG. 3A, when values of x, y, and cv are received by the input unit 110, the received values of x, y, and cv may be stored in a register 111 of the input unit 110. Accordingly, the conditional swap unit 121 may perform an operation, such as Equation 4, based on the values of x, y, and cv stored in the register 111.

For example, when value of cv is 0, the conditional swap unit 121 may left-shift an intermediate value (y−x) of the conditional swap operation by 0. Since (y−x) left-shifted by 0 is still (y−x), the conditional swap unit 121 may perform an operation 2x−y+y−x based on (y−x) to output x.

When the value of cv is 1, the conditional swap unit 121 may left-shift (y−x), an intermediate value of the conditional swap operation, by 1. In an example embodiment, (y−x) left-shifted by 1 becomes (2y−x), so the conditional swap unit 121 may perform an operation 2x−y+2y−x based on (2y−x) to output y, a result value of the swap operation.

From Equation 4, it can be seen that the same operation is performed regardless of the value of cv, so that a conditional swap operation, secure against timing attacks, may be performed. In addition, it can be seen that the intermediate value cv corresponding to the control value becomes, for example, 0(0x00000000) or 1(0x00000001), so that a Hamming weight difference may be significantly reduced, allowing a conditional swap operation, secure against power analysis attacks, to be performed.

According to an example embodiment, the conditional swap unit 121 may perform a conditional swap operation based on an operation of multiplying a control value by an intermediate value of the conditional swap operation.

FIG. 3B is a diagram illustrating an example of how the conditional swap unit 121 performs a conditional swap operation based on an operation of multiplying the control value. FIG. 3B illustrates the case in which a first value is 0 and a second value is 1, but example embodiments are not limited thereto.

According to an example embodiment, the conditional swap unit 121 may perform a conditional swap operation based on Equation 5, a conditional swap operation equation.

$$x + ( y - x ) * cv , \qquad [ Equation 5 ]$$

where x is a first operand, y is a second operand, cv is a control value, − is a subtraction operator, + is an addition operator, * is a multiplication operator, and the operation order complies with the standard operation order.

Referring to FIG. 3B, when values of x, y, and cv are received by the input unit 110, the received values of x, y, and cv may be stored in a register 111 of the input unit 110. Accordingly, the conditional swap unit 121 may perform an operation, such as Equation 5, based on the values of x, y, and cv stored in the register 111.

For example, when the value of cv is 0, the conditional swap unit 121 may perform an operation of multiplying 0 by an intermediate value (y−x) of the conditional swap operation. Multiplying (y−x) by 0 results in 0, so that the conditional swap unit 121 may output x.

When the value of cv is 1, the conditional swap unit 121 may perform an operation of multiplying 1 by the intermediate value (y−x) of the conditional swap operation. Multiplying (y−x) by 1 still results in (y−x), so that the conditional swap unit 121 may perform an operation x+(y−x) to output y, a result of the swap operation.

From Equation 5, it can be seen that the same operation is performed regardless of the value of cv, so that a conditional swap operation, secure against timing attacks, may be performed. In addition, it can be seen that an intermediate value cv corresponding to the control value becomes, for example, 0(0x00000000) or 1(0x00000001), so that a Hamming weight difference may be significantly reduced, allowing a conditional swap operation, secure power analysis attacks, to be performed.

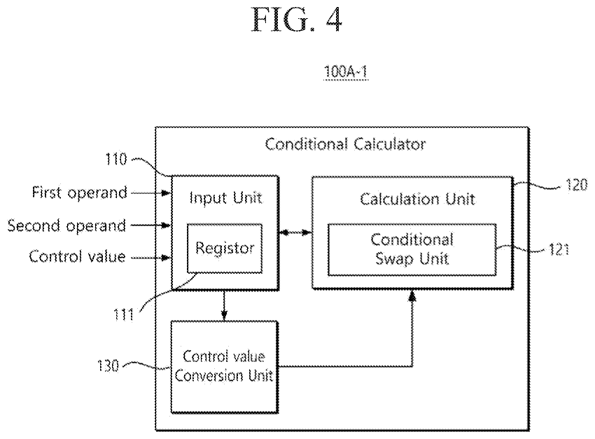

FIG. 4 is a block diagram illustrating the configuration of a conditional calculator according to an example embodiment. For FIG. 4, descriptions already given in FIGS. 2 to 3B will be omitted to avoid repetition. Referring to FIG. 4, a conditional calculator 100A-1 may further include a control value conversion unit 130, compared to the conditional calculator 100A of FIG. 2.

Equations 4 and 5 described above and Equation 6 to be described later may be valid conditional swap equations when 0 or 1 is used as a control value. Accordingly, a control value needs to be converted into 0 or 1 to perform a valid conditional swap operation using an operation based on Equations 4, 5, and 6 even when a value, other than 0 or 1, is received as the control value.

To this end, according to an example embodiment, the conditional calculator 100A-1 may include a control value conversion unit 130. The control value conversion unit 130 may convert a value, received as a control value that is not 0 or 1, into 0 or 1 and provide the converted value to a calculation unit 120. For example, the control value conversion unit 130 may convert a first value into 0 and a second value into 1, but example embodiments are not limited thereto.

Accordingly, the conditional swap unit 121 may perform a conditional swap operation based on the control value, provided by the control value conversion unit 130, to a valid conditional swap operation through an equation such as Equation 4, 5, or 6 even when a control value, other than 0 or 1, is received by the input unit 110.

However, example embodiments are not limited thereto. For example, an additional equation may be provided to perform a conditional swap operation based on a control value other than 0 or 1. Thus, the conditional swap unit 121 may execute the provided additional equation to perform a conditional swap operation without the control value conversion unit 130 even when a control value, other than 0 or 1, is received by the input unit 110. Even in this case, intermediate values included in the additional equation should be selected in consideration of a Hamming weight difference based on the control value.

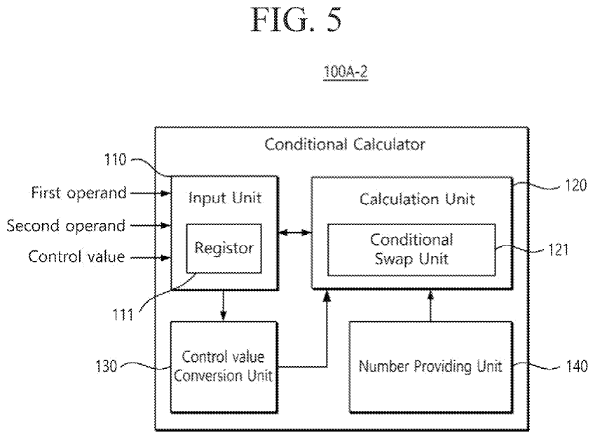

FIG. 5 is a block diagram illustrating the configuration of a conditional calculator according to an example embodiment. For FIG. 5, descriptions already given in FIGS. 2 to 4 will be omitted to avoid repetition. Referring to FIG. 5, a conditional calculator 100A-2 may further include a number providing unit 140, compared to the conditional calculator 100A-1 of FIG. 4.

According to an example embodiment, a conditional swap unit 121 may perform a conditional swap operation using two numbers having the same Hamming weight. To this end, a conditional calculator 100A-2 may include a number providing unit 140. The number providing unit 140 may provide two different numbers having the same Hamming weight to the calculation unit 120. For example, the number providing unit 140 may generate two different numbers having the same Hamming weight through a random number generator and provide the generated two numbers to a calculation unit 120. Alternatively, the number providing unit 140 may provide two previously stored numbers having the same Hamming weight to the calculation unit 120.

According to an embodiment, the two numbers provided by the number providing unit 140 may satisfy the condition that the two numbers have the same Hamming weight, and are maximum integers when an exclusive OR (XOR) operation is performed. If the two numbers are maximum integers when an exclusive OR (XOR) operation is performed, it indicates that corresponding bits in each number are complementary.

Accordingly, the conditional swap unit 121 may perform a conditional swap operation based on the two numbers provided by the number providing unit 140.

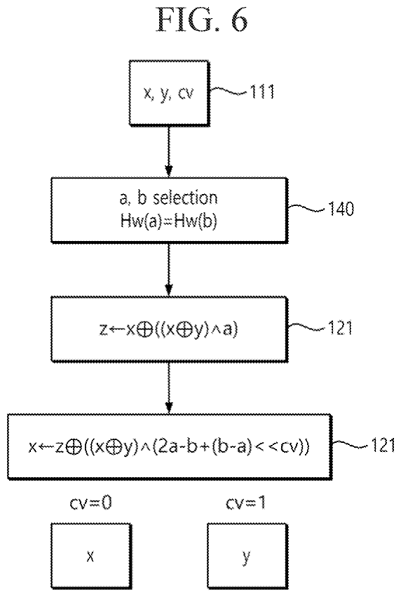

FIG. 6 is a diagram illustrating an embodiment in which the conditional swap unit 121 performs a conditional swap operation using two numbers having the same Hamming weight. FIG. 6 illustrates the case in which a first value is 0 and a second value is 1, but example embodiments are not limited thereto.

According to an example embodiment, the conditional swap unit 121 may perform a conditional swap operation based on the following Equation 6, a conditional swap operation equation.

$$z ← x ⊕ ( ( x ⊕ y ) ∧ a ) \qquad [ Equation 6 ]$$

$$x ← z ⊕ ( ( x ⊕ y ) ∧ ( 2 a - b + ( b - a ) ≪ cv ) ) ,$$

where x is a first operand, y is a second operand, cv is a control value, a and b are two numbers having the same Hamming weight, z is a variable in which a result value of the x⊕((x⊕y)Λa) operation is stored, ⊕ is an exclusive OR (XOR) operator, Λ is a logical AND operator, − is a subtraction operator, + is an addition operator, << is a left-shift operator, and the operation order complies with the standard operation order.

Referring to FIG. 6, when values of x, y, and cv are received by an input unit 110, the received values of x, y, and cv may be stored in a register 111 of the input unit 110. In addition, a number providing unit 140 may select two numbers “a” and “b” and provide the selected numbers “a” and “b” to a calculation unit 120. In an example embodiment, it may be confirmed that a Hamming weight Hw(a) of “a” and a Hamming weight Hw(b) of “b” are the same. In an example embodiment, the selected numbers “a” and “b” may be maximum integers when an exclusive OR (XOR) operation is performed.

Accordingly, the conditional swap unit 121 may perform an operation, such as Equation 6, based on the values of x, y, and cv stored in the register 111 and values of “a” and “b” provided by the number providing unit 140.

For example, the conditional swap unit 121 may perform a conditional swap operation by returning a result value of the operation x⊕((x⊕y)Λa) to a variable z, performing an exclusive OR (XOR) operation on a value of z and a value of ((x⊕y)Λ(2a−b+(b−a)<<cv)), and returning a result value of the XOR operation to x.

When the value of cv is 0, the conditional swap unit 121 may left-shift an intermediate value (b−a) of the conditional swap operation by 0. Since (b−a) left-shifted by 0 is still (b−a), the conditional swap unit 121 may perform an operation z⊕((x+y)Λa) to output the value of x.

When the value of cv is 1, the conditional swap unit 121 may left-shift the intermediate value (b−a) of the conditional swap operation. Since (b−a) left-shifted by 1 becomes 2 (b−a), the conditional swap unit 121 may perform the operation z⊕((x⊕y)Λb) to output y, a result value of the swap operation.

From Equation 6, it can be seen that the same operation is performed regardless of the value of cv, so that a conditional swap operation, secure against timing attacks, is performed. In addition, it can be seen that the intermediate value of cv corresponding to the control value becomes, for example, 0(0x00000000) or 1(0x00000001), so that the Hamming weight difference may be significantly reduced, allowing a conditional swap operation, secure from power analysis attacks, to be performed.

In Equation 6, the intermediate variable z is used. However, in some embodiments, an operation may be performed without using the intermediate variable z in a manner such as x←(x⊕((x⊕y)Λa)) ⊕((x⊕y)/(2a−b+(b−a)<<cv)).

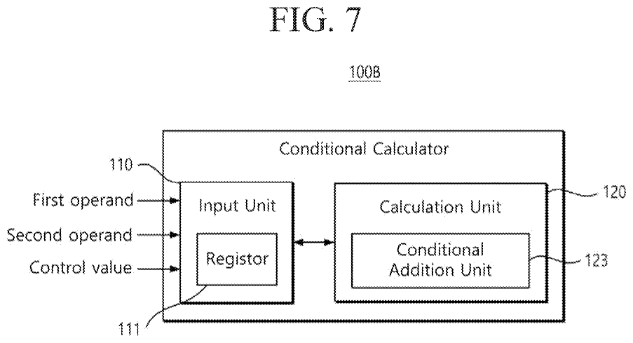

Hereinafter, various embodiments related to the conditional addition operation will be described with reference to FIGS. 7 to 10. For FIGS. 7 to 10, descriptions already given in FIGS. 2 to 6 will be omitted or simplified to avoid repetition.

FIG. 7 is a block diagram illustrating the configuration of a conditional calculator according to an example embodiment. Referring to FIG. 7, a conditional calculator 100B may include a conditional addition unit 123 rather than the conditional swap unit 121, compared to the conditional calculator 100A of FIG. 2.

The calculation unit 120 may perform a conditional addition operation. To this end, the calculation unit 120 may include a conditional addition unit 123. The conditional addition unit 123 may perform a conditional addition operation to add a second operand to a first operand based on a control value.

According to an example embodiment, the conditional addition unit 123 may perform a conditional addition operation based on an operation of left-shifting an intermediate value of the conditional addition operation based on the control value. The control value may include a first value, representing a condition in which a swap operation is not performed, and a second value representing a condition in which the swap operation is performed.

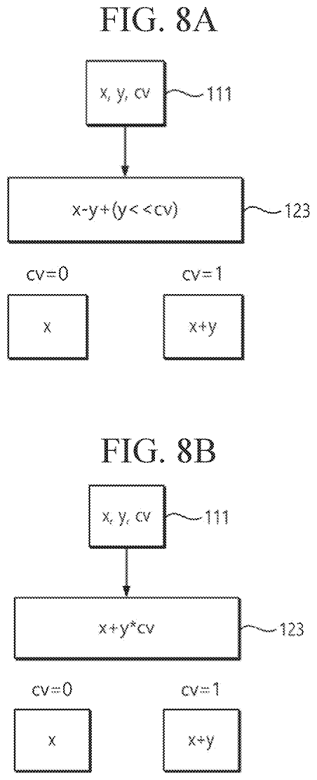

FIG. 8A is a diagram illustrating an example in which the conditional addition unit 123 performs a conditional addition operation based on a left-shift operation. FIG. 8A illustrates the case in which a first value is 0 and a second value is 1, but example embodiments are not limited thereto.

According to an example embodiment, the conditional addition unit 123 may perform a conditional addition operation based on the following Equation 7, a conditional addition equation.

$$x - y + ( y ≪ cv ) , \qquad [ Equation 7 ]$$

where x is the first operand, y is the second operand, cv is the control value, − is a subtraction operator, + is an addition operator, << is a left-shift operator, and the operation order complies with the standard operation order.

Referring to FIG. 8A, the conditional addition unit 123 may perform an operation, such as Equation 7, based on values of x, y, and cv stored in a register 111.

For example, when the value of cv is 0, the conditional addition unit 123 may left-shift an intermediate value y of the conditional addition operation by 0. Since y left-shifted by 0 is still y, the conditional addition unit 123 may perform an operation x−y+y to output x.

When the value of cv is 1, the conditional addition unit 123 may left-shift the intermediate value y of the conditional addition operation by 1. Since y left-shifted by 1 becomes 2y, the conditional addition unit 123 may perform an operation x−y+2y to output x+y, a result of the addition operation.

From Equation 7, it can be seen that the same operation is performed regardless of the value of cv, so that a conditional addition operation, secure against side-channel attacks, may be performed. In addition, it can be seen that the intermediate value cv corresponding to the control value becomes, for example, 0(0x00000000) or 1(0x00000001), so that a Hamming weight difference may be significantly reduced, allowing a conditional addition operation, secure against power analysis attacks, to be performed.

According to an example embodiment, the conditional addition unit 123 may perform a conditional addition operation based on an operation of multiplying the control value by the intermediate value of the conditional addition operation.

FIG. 8B is a diagram illustrating an example in which the conditional addition unit 123 performs a conditional addition operation based on the operation of multiplying a control value. FIG. 8B illustrates the case in which a first value is 0 and a second value is 1, but example embodiments are not limited thereto.

According to an example embodiment, the conditional addition unit 123 may perform a conditional addition operation based on the following Equation 8, a conditional addition operation equation.

$$x + ( y ) * cv , \qquad [ Equation 8 ]$$

where x is the first operand, y is the second operand, cv is the control value, + is the addition operator, * is a multiplication operator, and the operation order complies with the standard operation order.

Referring to FIG. 8B, a conditional addition unit 123 may perform an operation, such as Equation 8, based on values of x, y, and cv stored in a register 111.

For example, when the value of cv is 0, the conditional addition unit 123 may perform an operation of multiplying an intermediate value y of the conditional addition operation by 0. Multiplying y by 0 still results in 0, so that the conditional addition unit 123 may output x.

When the value of cv is 1, the conditional addition unit 123 may perform an operation of multiplying the intermediate value y of the conditional addition operation by 1. Multiplying y by 1 gives y, so that the conditional addition unit 123 may output x+y, a result value of the addition operation.

From Equation 8, it can be seen that the same operation is performed regardless of the value of cv, so that a conditional addition operation, secure against side-channel attacks, may be performed. In addition, it can be seen that the intermediate value cv corresponding to the control value becomes, for example, 0(0x00000000) or 1(0x00000001), so that a Hamming weight difference may be significantly reduced, allowing a conditional addition operation, secure against power analysis attacks, to be performed.

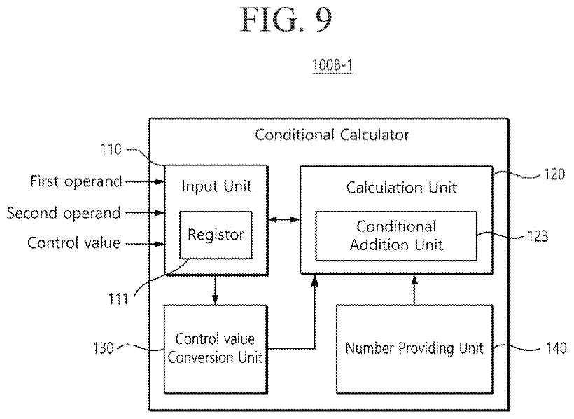

FIG. 9 is a block diagram illustrating the configuration of a conditional operation device according to an example embodiment. Referring to FIG. 9, a conditional calculator 100B-1 may include a conditional addition unit 123 rather than the conditional swap unit 121, compared to the conditional calculator 100A-2 of FIG. 5.

A control value conversion unit 130 of the conditional operation device 100B-1 may convert a control value, received as a value other than 0 or 1, into 0 or 1 and provide the converted control value to a calculation unit 120. Accordingly, the conditional addition unit 123 may perform a conditional addition operation based on the control value provided by the control value conversion unit 130. Thus, a valid conditional addition operation may be performed through an operation such as Equations 7, 8, or 9 even when a control value, other than 0 or 1, is received.

According to an example embodiment, the conditional addition unit 123 may perform a conditional addition operation using two numbers having the same Hamming weight. To this end, the conditional calculator 100B-1 may include a number providing unit 140. According to an example embodiment, the number providing unit 140 may provide a calculation unit 120 with two numbers satisfying a conditions in which the two numbers have the same Hamming weight and are maximum integers when an exclusive OR (XOR) operation is performed. Accordingly, the conditional addition unit 123 may perform a conditional addition operation based on the two numbers provided by the number providing unit 140.

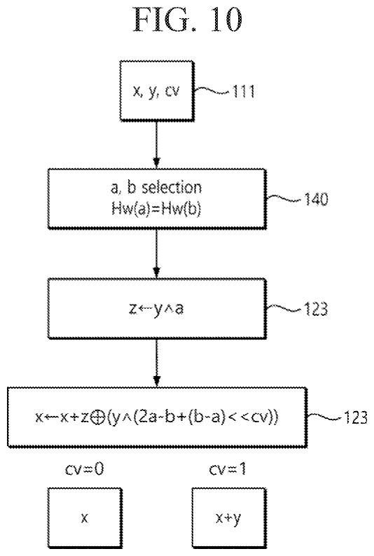

FIG. 10 is a diagram illustrating an example in which a conditional addition unit 123 performs a conditional addition operation using two numbers having the same Hamming weight. FIG. 10 illustrates the case in which a first value is 0 and a second value, but example embodiments are not limited thereto.

According to an example embodiment, the conditional addition unit 123 may perform a conditional addition operation based on the following Equation 9, a conditional addition operation equation.

$$z ← y ∧ a \qquad [ Equation 9 ]$$

$$x ← x + z ⊕ ( y ∧ ( 2 a - b + ( b - a ) ≪ cv ) ) ,$$

where x is a first operand, y is a second operand, cv is the control value, “a” and “b” are two numbers having the same Hamming weight, z is a variable in which a result value of an operation yΛa is stored, ⊕ is an exclusive OR (XOR) operator, Λ is a logical AND operator, − is a subtraction operator, + is an addition operator, << is a left-shift operator, and the operation order complies with the standard operation order.

Referring to FIG. 10, a conditional addition unit 123 may perform an operation, such as Equation 9, based on x, y, and cv stored in a resister 111 and the two numbers “a” and “b,” provided from a number providing unit 140, which have the same Hamming weight and are maximum integers when an exclusive OR (XOR) operation is performed.

For example, a conditional addition unit 123 may perform a conditional addition operation by returning a value of an operation yΛa to a variable z, performing an exclusive OR (XOR) operation on a value of z and a value of yΛ2a−b+b−a<<cv, and summing a result value with x.

In an example embodiment, when the value of cv is 0, the conditional addition unit 123 may left-shift an intermediate value (b−a) of the conditional addition operation by 0. Since (b−a) left-shifted by 0 is still (b−a), the conditional addition unit 123 may perform an operation x+z⊕(yΛa). In an example embodiment, z is (yΛa), so that z⊕(yΛa) may be 0 and the conditional addition unit 123 may output a value of x as it is.

When the value of cv is 1, the conditional addition unit 123 may left-shift the intermediate value (b−a) of the conditional addition operation by 1. Since (b−a) left-shifted by 1 becomes 2(b−a), the conditional addition unit 123 may perform an operation x+z⊕(yΛb). In an example embodiment, z is (yΛa), so that z⊕(yΛb) may be y and the conditional addition unit 123 may output (x+y), a result of the addition operation.

From Equation 9, it can be seen that the same operation is performed regardless of the value of cv, allowing a conditional addition operation, secure against side-channel attacks, to be performed. In addition, it can be seen that an intermediate value cv corresponding to the control value becomes, for example, 0(0x00000000) or 1(0x00000001), so that a Hamming weight difference may be significantly reduced, allowing a conditional addition operation, secure against power analysis attacks, to be performed.

An intermediate variable z is used in mathematical equation 9, but an operation using no z, such as x←x+(yΛa)⊕(yΛ(2a−b+(b−a)<<cv)), may be performed according to example embodiments.

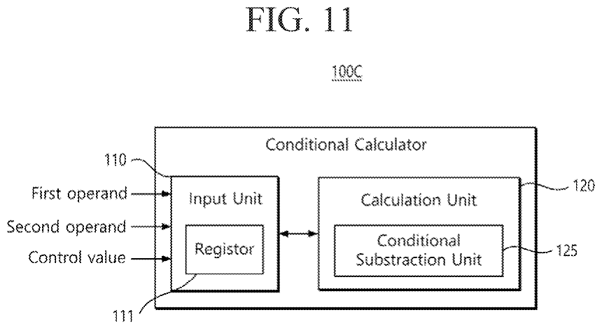

Hereinafter, various embodiments related to a conditional subtraction operation will be described with reference to FIGS. 11 to 14. For FIGS. 11 to 14, descriptions already given will be omitted or simplified to avoid repetition.

FIG. 11 is a block diagram illustrating the configuration of a conditional calculator according to an example embodiment. Referring to FIG. 11, a conditional calculator 100C may include a conditional subtraction unit 125, rather than of a conditional swap unit 121, compared to the conditional calculator 100A of FIG. 2.

A calculation unit 120 may perform a conditional subtraction operation. To this end, the calculation unit 120 may include a conditional subtraction unit 125. The conditional subtraction unit 125 may perform a conditional subtraction operation to subtract a second operand from a first operand based on a control value.

According to an example embodiment, the conditional subtraction unit 125 may perform a conditional subtraction operation based on an operation that left-shifts an intermediate value of the conditional subtraction operation according to the control value. The control value may include a first value, representing a condition in which a swap operation is not performed, and a second value representing a condition in which a swap operation is performed.

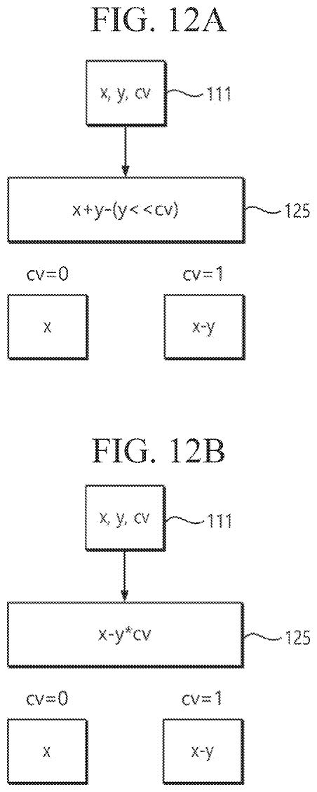

FIG. 12A is a diagram illustrating an example embodiment in which a conditional subtraction unit 125 performs a conditional subtraction operation based on a left-shift operation. FIG. 12A illustrates the case in which a first value is 0 and a second value is 1, but example embodiments are not limited thereto.

According to an example embodiment, a conditional subtraction unit 125 may perform a conditional subtraction operation based on a conditional subtraction operation equation such as the following Equation 10.

$$x + y - ( y ≪ cv ) , \qquad [ Equation 10 ]$$

where x is a first operand, y is a second operand, cv is the control value, − is a subtraction operator, + is an addition operator, << is a left-shift operator, and the operation order complies with the standard operation order.

Referring to FIG. 12A, the conditional subtraction unit 125 may perform an operation, such as Equation 10, based on values of x, y, and cv stored in a register 111.

For example, when a value of cv is 0, the conditional subtraction unit 125 may left-shift an intermediate value y of the conditional subtraction operation by 0. Since y left-shifted by 0 is still y, the conditional subtraction unit 125 may perform an operation x+y−y to output x.

When the of cv is 1, the conditional subtraction unit 125 may left-shift the intermediate value y of the conditional subtraction operation by 1. Since y left-shifted by 1 becomes 2y, the conditional subtraction unit 125 may perform an operation x+y−2y to output x−y, a result value of the subtraction operation.

From Equation 10, it can be seen that the same operation is performed regardless of the value of cv, so that a conditional subtraction operation, secure against side-channel attacks, may be performed. In addition, an intermediate value cv corresponding to the control value becomes, for example, 0(0x00000000) or 1(0x00000001), so that a Hamming weight difference may be significantly reduced, allowing a conditional subtraction operation, secure against power analysis attacks, to be performed.

According to an embodiment, the conditional subtraction unit 125 may perform a conditional subtraction operation based on an operation of multiplying the control value by the intermediate value of the conditional subtraction operation.

FIG. 12B is a diagram illustrating an example of performing a conditional subtraction operation based on a multiplication calculation of a control value. FIG. 12B illustrates the case in which a first value is 0 and a second value is 1, but example embodiments are not limited thereto.

According to an example embodiment, the conditional subtraction unit 125 may perform a subtraction operation based on a conditional subtraction operation equation such as the following Equation 11.

$$x - ( y ) * cv , \qquad [ Equation 11 ]$$

where x represents a first operand, y represents a second operand, cv represents a control value, − represents the subtraction operator, * represents the multiplication operator, and the operation sequence complies with the standard operation sequence.

Referring to FIG. 12B, a conditional subtraction unit 125 may perform an operation, such as the following Equation 12, based on values of x, y, and cv stored in a register 111.

For example, when the value of cv is 0, the conditional subtraction unit 125 may perform an operation of multiplying 0 by y, an intermediate value of the conditional subtraction operation. Multiplying y by 0 results in 0, so that the conditional subtraction unit 125 may output x.

When the value of cv is 1, the conditional subtraction unit 125 may perform an operation of multiplying 1 by y, an intermediate value of the conditional subtraction operation. Multiplying y by 1 results in y, so that the conditional subtraction unit 125 may output x−y, a result value of the subtraction operation.

From Equation 11, it can be seen that the same operation is performed regardless of the value of cv, so that a conditional addition operation, secure against side-channel attacks, may be performed. In addition, the intermediate value cv corresponding to the control value becomes, for example, 0(0x00000000) or 1(0x00000001), so that a Hamming weight difference may be significantly reduced, allowing a conditional addition operation, secure against power analysis attacks, to be performed.

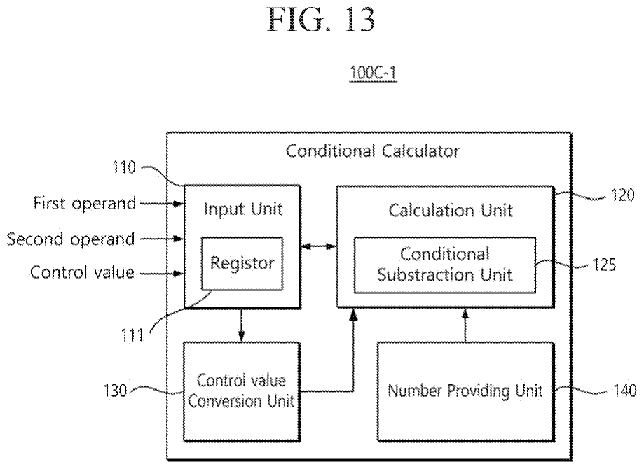

FIG. 13 is a block diagram illustrating the configuration of a conditional calculator according to an example embodiment. Referring to FIG. 13, a conditional calculator 100C-1 may include a conditional subtraction unit 125, rather than a conditional swap unit 121, compared to the conditional calculator 100A-2 of FIG. 5.

A control value conversion unit 130 of the conditional calculator 100C-1 may convert a control value, received when a value other than 0 or 1 is received as a control value, into 0 or 1 and provide the converted value to a calculation unit 120. Accordingly, the conditional subtraction unit 125 may perform a conditional addition operation based on the control value, provided by the control value conversion unit 130, to perform a valid conditional subtraction operation through an operation such as Equation 10, Equation 11, or Equation 12 even when a control value other than 0 or 1 is received.

According to an example embodiment, the conditional subtraction unit 125 may perform a conditional subtraction operation using two numbers having the same Hamming weight. To this end, the conditional calculator 100C-1 may include a number providing unit 140. In an example embodiment, the number providing unit 140 may provide two numbers, satisfying the condition that the two numbers have the same Hamming weight and are maximum integers when an exclusive OR (XOR) operation is performed, to the calculation unit 120. Accordingly, the conditional subtraction unit 125 may perform a conditional subtraction operation based on the two numbers provided by the number providing unit 140.

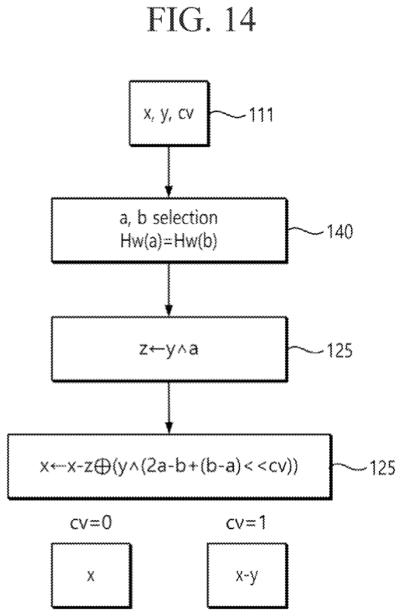

FIG. 14 is a diagram illustrating an example in which a conditional subtraction unit 125 performs a conditional subtraction operation using two numbers having the same Hamming weight. FIG. 14 illustrates the case in which a first value is 0 and a second value is 1, but the example embodiments are not limited thereto.

According to an example embodiment, the conditional subtraction unit 125 may perform a conditional addition operation based on a conditional subtraction operation equation such as the following Equation 12.

$$z ← y ∧ a \qquad [ Equation 12 ]$$

$$x ← x - z ⊕ ( y ∧ ( 2 a - b + ( b - a ) ≪ cv ) ) ,$$

where x represents a first operand, y represents a second operand, cv represents a control value, “a” and “b” represent two numbers having the same Hamming weight, z represents a variable in which a value of an operation yΛa is stored, ⊕ represents an exclusive OR (XOR) operator, Λ represents a logical AND operator, − represents a subtraction operator, + represents an addition operator, << represents a left-shift operator, and the operation order complies with the standard operation sequence.

Referring to FIG. 14, the conditional subtraction unit 125 may perform an operation, such as Equation 12, based on values of x, y, and cv, stored in a register 111 and two numbers “a” and “b,” provided from the number providing unit 140, which have the same Hamming weight and are maximum integers when an exclusive OR (XOR) operation is performed.

For example, the conditional subtraction unit 125 may store a value of an operation yΛa in a variable z, perform an exclusive OR (XOR) operation on the values of z and yΛ2a−b+b−a<<cv, and subtract the result from x to perform a conditional subtraction operation.

When the value of cv is 0, the conditional subtraction unit 125 may left-shift an intermediate value (b−a) of the conditional subtraction operation by 0. Since (b−a) left-shifted by 0 is still (b−a), the conditional subtraction unit 125 may perform an operation of x−z⊕(yΛa). In an example embodiment, z is yΛa, so that z⊕(yΛa) may be 0 and the conditional subtraction unit 125 may output the value of x as it is.

When the value of cv is 1, the conditional subtraction unit 125 may left-shift an intermediate value (b−a) of the conditional subtraction operation by 1. Since (b−a) left-shifted by 1 becomes 2 (b−a), the conditional subtraction unit 125 may perform an operation x−z⊕(yΛb). Since z is (yΛa), z⊕(yΛb) may be y and the conditional subtraction unit 125 may output x−y, a result of the subtraction operation.

From Equation 12, it can be seen that the same operation is performed regardless of the value of cv, so that a conditional subtraction operation, secure against side-channel attacks, may be performed. In addition, an intermediate value cv corresponding to the control value becomes, for example, 0(0x00000000) or 1(0x00000001), so that a Hamming weight difference may be significantly reduced, allowing a conditional subtraction operation, secure against power analysis attacks, to be performed.

An intermediate variable z is used in mathematical formula 12, but an operation using no z, such as x←x−(yΛa)⊕(yΛ(2a−b+(b−a)<<cv)), may be performed according to example embodiments.

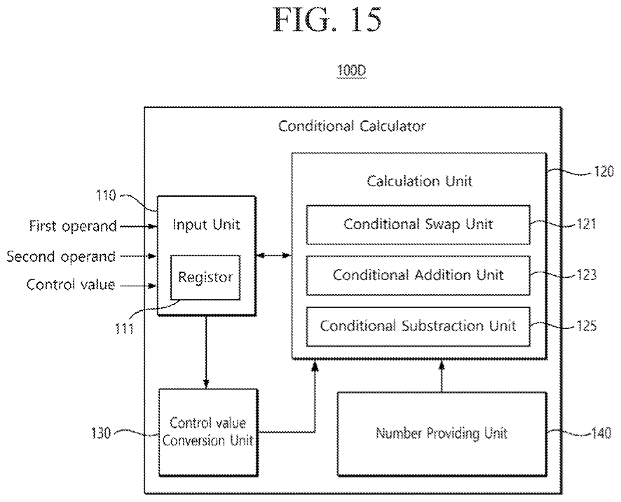

FIG. 15 is a block diagram illustrating the configuration of a conditional calculator according to an example embodiment. For FIGS. 11 to 14, descriptions already given will be omitted to avoid repetition.

Referring to FIG. 15, a conditional calculator 100D may include an input unit 110, a calculation unit 120, a control value conversion unit 130, and a number providing unit 140. The calculation unit 120 may include a conditional swap unit 121, a conditional addition unit 123, and a conditional subtraction unit 125.

Each of the conditional swap unit 121, the conditional addition unit 123, and the conditional subtraction unit 125 may include at least one of an arithmetic operation unit performing four fundamental arithmetic operations, a logical operation unit performing a logical operation, and a shift operation unit performing a shift operation, to perform a corresponding operation, but example embodiments are not limited thereto.

The conditional calculation unit 100D may be implemented as a hardware intellectual property (IP). The term “hardware IP” refers to a reusable hardware IP. For example, the conditional calculator 100D may be implemented as an application specific integrated circuit (ASIC) or a field programmable gate array (FPGA), but example embodiments are not limited thereto.

The conditional calculation unit 100D implemented as hardware IP may be included within a processor in the form of system-on-chip (SoC), or may be implemented as an additional chip.

In FIG. 15, the operation unit 120 is illustrated as including all of the conditional swap unit 121, the conditional addition unit 123, and the conditional subtraction unit 125, but this is only an example embodiment. The operation unit 120 may include at least one of the conditional swap unit 121, the conditional addition unit 123, and the conditional subtraction unit 125.

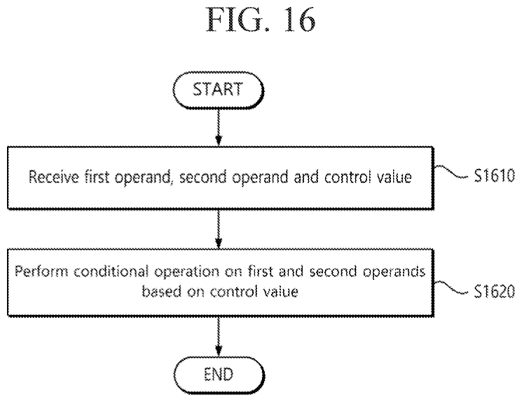

FIG. 16 is a flowchart illustrating a conditional calculation method according to an example embodiment. According to an example embodiment, the operations of the above-described conditional calculation units 100, 100A, 100A-1, 100A-2, 100B, 100B-1, 100C, 100C-1, and 100D may be implemented as software IP.

For example, the above-mentioned conditional swap unit 121, conditional addition unit 123, and/or conditional subtraction unit 125 may each be implemented as software IP. In an example embodiment, a processor may execute the conditional swap unit 121, the conditional addition unit 123, and/or the conditional subtraction unit 125, implemented as software IP, to perform the above-mentioned conditional swap operation, conditional addition operation, and/or a conditional subtraction operation, respectively.

As described above, logical operations (for example, exclusive OR (XOR), logical AND, and shift operations) may be performed in units of bits.

Referring to FIG. 16, in operation S1610, the processor may receive a first operand, a second operand, and a control value.

Accordingly, in operation S1620, the processor may perform a conditional operation in which a predetermined operation is performed or not performed on the first and second operands, based on the control value. For example, the processor may perform a conditional operation based on an operation of left-shifting an intermediate value of the conditional operation according to the control value or an operation of multiplying the control value by the intermediate value of the conditional operation.

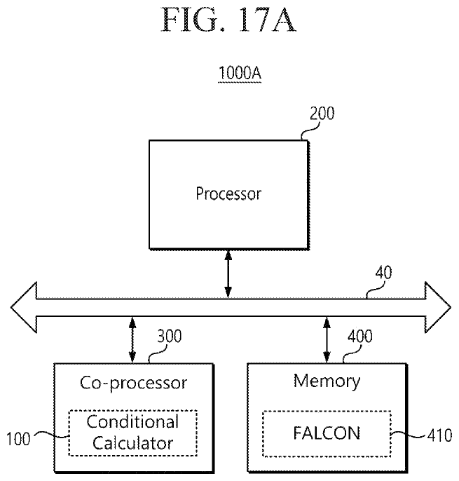

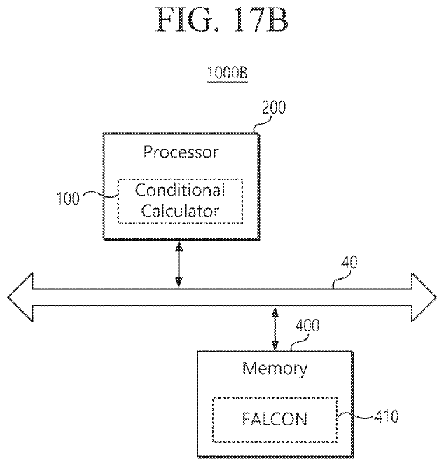

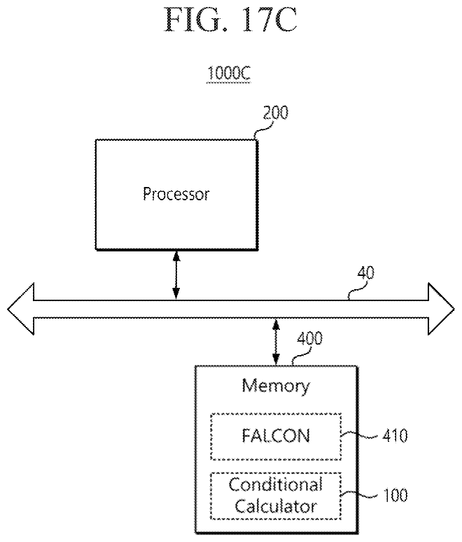

Hereinafter, various examples of how to implement the conditional calculator 100 will be described with reference to FIGS. 17A to 17C.

FIG. 17A is a diagram illustrating an example of how to implement a conditional calculation system according to an example embodiment. According to FIG. 17A, a conditional operation system 1000A may include a processor 200, a co-processor 300, and a memory 400. The processor 200, the co-processor 300, and the memory 400 may transmit and receive data to and from each other through a bus 40.

The memory 400 may be used as a main memory device of the conditional operation system 1000A, and may include a volatile memory such as an SRAM and/or a DRAM. In addition, the memory 400 may include a nonvolatile memory such as a flash memory, a PRAM, and/or an RRAM.

The co-processor 300 may be an accelerator for various operations performed by the processor 200. In an example embodiment, the co-processor 300 may include a conditional calculation unit 100 according to various example embodiments.

The processor 200 may control the overall operation of the conditional calculation system 1000A. The processor 200 may include one or more of a central processing unit (CPU), a controller, an application processor (AP), a microprocessor unit (MPU), a communication processor (CP), a graphics processing unit (GPU), a vision processing unit (VPU), a neural processing unit (NPU), or an ARM processor.

For example, the processor 200 may execute a FALCON algorithm 410 stored in the memory 400. In an example embodiment, the processor 200 may execute the conditional calculator 100, implemented as the co-processor 300, to perform various conditional calculations used during a key generation process of the FALCON algorithm 410.

FIG. 17b is a diagram illustrating an example of how to implement a conditional calculation system according to an example embodiment. For FIG. 17B, descriptions already given in FIG. 17A will be omitted to avoid repetition. Referring to FIG. 17B, the conditional calculation system 1000B may include a processor 200 and a memory 400. In an example embodiment, the above-described conditional calculator 100 may be implemented inside the processor 200, as illustrated in FIG. 17B. In an example embodiment, the processor 200 may directly use the conditional calculator 100, disposed therein, during a process of generating keys based on a FALCON algorithm 410.

FIG. 17C is a diagram illustrating an example of how to implement a conditional calculation system according to an example embodiment. For FIG. 17C, descriptions already given in FIG. 17A will be omitted to avoid repetition. Referring to FIG. 17C, a conditional calculation system 1000C may include a processor 200 and a memory 400. In an example embodiment, the above-described conditional calculator 100 may be implemented as software and stored in the memory 400, as illustrated in FIG. 17C. In an example embodiment, the processor 200 may execute the conditional calculator 100 stored in the memory 400, and use the executed conditional calculator 100 in a key generation process of a FALCON algorithm 410.

When the conditional calculator 100 implemented as hardware IP is used as illustrated in FIG. 17A or FIG. 17B, conditional calculations may be performed at a significantly higher speed than when the conditional calculation unit 100 implemented as software IP is used as illustrated in FIG. 17C.

Although there is a difference in operation speed, the conditional calculation systems 1000A, 1000B, and 1000C in FIGS. 17A to 17C all perform conditional calculations using the conditional calculators 100 according to various embodiments. Therefore, conditional calculations, secure against side-channel attacks such as timing attacks and power analysis attacks, may be performed.

The conditional calculation systems 1000A, 1000B, 1000C described above in FIGS. 17A to 17C may be implemented in various electronic devices such as a smartphone, a tablet personal computer (PC), a laptop PC, a PC, a smart TV, a smart home appliance, a wearable device, a healthcare device, a server, or a navigation system.

Although descriptions have been mainly provided with respect to conditional calculations (a conditional swap operation, a conditional addition operation, or a conditional subtraction operation) used in a key generation process of a FALCON algorithm, example embodiments are not limited thereto, and the conditional calculators 100 according to various embodiments may be applied to any field in which conditional calculations are used.

According to the above-described various embodiments, conditional calculations, secured against side-channel attacks, for example, timing attacks and power analysis attacks, may be performed.

According to an example embodiment, the method of operating a conditional calculator according to various embodiments may be provided to be included in a computer program product. The computer program product may be exchanged between a seller and a purchaser as a commercially available product. The computer program product may be distributed in the form of a machine-readable storage medium (for example, compact disc read only memory (CD-ROM)) or distributed online through an application store (for example, PlayStore™). In a case of the on-line distribution, at least a part of the computer program product may be at least temporarily stored or temporarily generated in a storage medium such as a memory of a server of a manufacturer, a server of an application store, or a relay server.

Each of the elements (for example, a module or a program) according to various embodiments may be composed of a single entity or a plurality of entities, and some sub-elements of the abovementioned sub-elements may be omitted or other sub-elements may be further included in various embodiments. Alternatively or additionally, some elements (for example, modules or programs) may be integrated into one entity to perform the same or similar functions performed by each respective element prior to integration. Operations performed by a module, a program, or other elements, in accordance with various embodiments, may be performed sequentially, in a parallel, repetitive, or heuristically manner, or at least some operations may be performed in a different order, omitted, or may add a different operation.

As set forth above, according to example embodiments, a conditional calculator, a conditional calculation method, and a conditional calculation system for performing conditional calculations securely against side-channel attacks may be provided.

While example embodiments have been shown and described above, it will be apparent to those skilled in the art that modifications and variations could be made without departing from the scope of the present inventive concept as defined by the appended claims.

What is claimed is:

1. A conditional calculator comprising:
an input unit configured to receive a first operand, a second operand, and a control value; and
a calculation unit configured to perform a conditional operation in which a determination is made as to whether a predetermined operation is performed on the first and second operands, depending on the control value,
wherein
the calculation unit performs the conditional operation based on an operation of left-shifting an intermediate value of the conditional operation according to the control value or an operation of multiplying the intermediate value of the conditional operation by the control value.

2. The conditional calculator of claim 1, wherein
the control value comprises a first value, representing a condition in which the predetermined operation is not performed, and a second value representing a condition in which the predetermined operation is performed, and
the calculation unit is configured to:
left-shift the intermediate value of the conditional operation by the first value and output the first operand based on the intermediate value left-shifted by the first value when the control value is the first value; and
left-shift the intermediate value of the conditional operation by the second value and output a result value of the predetermined operation on the first and second operands based on the intermediate value left-shifted by the second value when the control value is the second value.

3. The conditional calculator of claim 2, wherein
the control value has a value of 0 or 1.

4. The conditional calculator of claim 3, comprising:
a control value conversion unit configured to convert the first and second values into 0 or 1 when the first and second values are not 0 or 1.

5. The conditional calculator of claim 3, wherein
the conditional operation comprises at least one of a conditional swap operation to replace the first operand with the second operand based on to the control value, a conditional addition operation to add the second operand to the first operand based on the control value, and a conditional subtraction operation to subtract the second operand from the first operand based on the control value.

6. The conditional calculator of claim 5, wherein
the calculation unit performs the conditional swap operation through the following equation:
$$2 x - y + ( y - x ) ≪ cv ,$$
where x is the first operand, y is the second operand, cv is the control value, − is a subtraction operator, + is an addition operator, << is a left-shift operator, and an operation order complies with a standard operation order.

7. The conditional calculator of claim 5, wherein
the calculation unit performs the conditional swap operation through the following equation:
$$z ← x ⊕ ( ( x ⊕ y ) ∧ a )$$
$$x ← z ⊕ ( ( x ⊕ y ) ∧ ( 2 a - b + ( b - a ) ≪ cv ) ) ,$$
where x is the first operand, y is the second operand, cv is the control value, a and b are arbitrary two numbers having the same Hamming weight, z is a variable in which a value of an operation x⊕((x⊕y)Λa) is stored, ⊕ is an exclusive OR (XOR) operator, Λ is a logical AND operator, − is a subtraction operator, + is an addition operator, << is a left-shift operator, and an operation order complies with a standard operation order.

8. The conditional calculator of claim 5, wherein
the calculation unit performs the conditional addition operation through the following equation:
$$x - y + ( y ≪ cv ) ,$$
where x is the first operand, y is the second operand, cv is the control value, − is a subtraction operator, + is an addition operator, << is a left-shift operator, and an operation order complies with a standard operation order.

9. The conditional calculator of claim 5, wherein
the calculation unit performs the conditional addition operation using the following equation:
$$z ← y ∧ a$$
$$x ← x + z ⊕ ( y ∧ ( 2 a - b + ( b - a ) ≪ cv ) ) ,$$
where x is the first operand, y is the second operand, cv is the control value, a and b are arbitrary two numbers having the same Hamming weight, z is a variable in which a value of an operation yΛa is stored, ⊕ is an exclusive OR (XOR) operator, Λ is a logical AND operator, − is a subtraction operator, + is an addition operator, << is a left-shift operator, and an operation order complies with a standard operation order.

10. The conditional calculator of claim 5, wherein
the calculation unit performs the conditional subtraction operation through the following equation:
$$x + y - ( y ≪ cv ) ,$$
where x is the first operand, y is the second operand, cv is the control value, − is a subtraction operator, + is an addition operator, << is a left-shift operator, and an operation order complies with a standard operation order.

11. The conditional calculator of claim 5, wherein
the calculation unit performs the conditional subtraction operation through the following equation:
$$z ← y ∧ a$$
$$x ← x - z ⊕ ( y ∧ ( 2 a - b + ( b - a ) ≪ cv ) ) ,$$
where x is the first operand, y is the second operand, cv is the control value, a and b are arbitrary two numbers having the same Hamming weight, z is a variable in which a value of an operation yΛa is stored, ⊕ is an exclusive OR (XOR) operator, Λ is a logical AND operator, − is a subtraction operator, + is an addition operator, << is a left-shift operator, and an operation order complies with a standard operation order.

12. The conditional calculator of claim 1, wherein
the control value comprises a first value, representing a condition in which the predetermined operation is not performed, and a second value representing a condition in which the predetermined operation is performed, and
the calculation unit is configured to:
output the first operand based on an operation of multiplying the intermediate value of the conditional operation by the first value when the control value is the first value; and
output a result value of the predetermined operation on the first and second operands based on an operation of multiplying the intermediate value of the conditional operation by the second value when the control value is the second value.

13. The conditional calculator of claim 12, wherein
the control value has a value of 0 or 1.

14. The conditional calculator of claim 13, comprising:
a control value conversion unit configured to convert the first and second values into 0 or 1 when the first and second values are not 0 or 1.

15. The conditional calculator of claim 13, wherein
the calculation unit performs a conditional swap operation to replace the first operand with the second operand based on the control value through the following equation:
$$x + ( y - x ) * cv ,$$
where x is the first operand, y is the second operand, cv is the control value, − is a subtraction operator, + is an addition operator, * is a multiplication operator, and an operation order complies with a standard operation order.

16. The conditional calculator of claim 13, wherein
the calculation unit performs a conditional addition operation to add the second operand to the first operand based on the control value through the following equation:
$$x + ( y ) * cv ,$$
where x is the first operand, y is the second operand, cv is the control value, + is an addition operator, * is a multiplication operator, and an operation order complies with a standard operation order.

17. The conditional calculator of claim 13, wherein
the calculation unit performs a conditional subtraction operation to subtract the second operand from the first operand based on the control value through the following equation:
$$x - ( y ) * cv ,$$
where x is the first operand, y is the second operand, cv is the control value, − is a subtraction operator, * is a multiplication operator, and an operation order complies with a standard operation order.

18. A conditional calculation method of a processor, the conditional calculation method comprising:
receiving a first operand, a second operand, and a control value; and
performing a conditional operation in which a predetermined operation is performed or not performed on the first and second operands, based on the control value,
wherein
the performing the conditional operation comprises performing the conditional operation based on an operation of left-shifting the intermediate value of the predetermined operation according to the control value or an operation of multiplying the intermediate value of the predetermined operation by the control value.

19. A conditional calculation system comprising:
a conditional calculator configured to perform a conditional operation in which whether a determination is made as to whether a predetermined operation is performed, based on a control value; and
a processor connected to the conditional calculator,
wherein
the processor provides a first operand, a second operand, and a control value to the conditional calculator, and
the conditional calculator performs the conditional operation on the first and second operands based on an operation of left-shifting an intermediate value of the predetermined operation according to the control value or an operation of multiplying the intermediate value of the predetermined operation by the control value, and returns a result of performing the conditional operation to the processor.

20. The conditional calculation system of claim 19, wherein
the predetermined operation comprises at least one of a conditional swap operation, a conditional addition operation, and a conditional subtraction operation used in a fast Fourier lattice-based compact signatures over NTRU (FALCON) algorithm.
